(19) United States
(12) Patent Application Publication
(10) Pub. No.: US 2013/0258736 A1
(43) Pub. Date: Oct. 3, 2013

(54) POWER CONVERTER

(71) Applicant: KABUSHIKI KAISHA YASKAWA DENKI, Kitakyushu-shi (JP)

(72) Inventors: Masato HIGUCHI, Kitakyushu-shi (JP); Yasuhiko KAWANAMI, Kitakyushu-shi (JP)

(73) Assignee: KABUSHIKI KAISHA YASKAWA DENKI, Kitakyushu-shi (JP)

(21) Appl. No.: 13/905,132

(22) Filed: May 30, 2013

Related U.S. Application Data
(63) Continuation of application No. PCT/JP2011/070126, filed on Sep. 5, 2011.

(30) Foreign Application Priority Data
Dec. 1, 2010 (JP) 2010-268744

(51) Int. Cl. H02M 7/537

(52) U.S. Cl. CPC H02M 7/537
USPC 363/131

(57) ABSTRACT

A power module includes a power module body portion. The power module body portion includes a P-side conductive plate, a first N-side conductive plate, and a second N-side conductive plate that are disposed with a distance thereamong in the power module body portion, P-side semiconductor elements that are disposed on a front surface of the P-side conductive plate, N-side semiconductor elements that are disposed on a front surface of the first N-side conductive plate and that are electrically connected to the P-side semiconductor elements, and a capacitor that is disposed between the P-side semiconductor elements and the N-side semiconductor elements so as to be connected to the P-side conductive plate and the second N-side conductive plate in the power module body portion and that suppresses a surge voltage.

### CROSS-REFERENCE TO RELATED APPLICATIONS

The present application is a continuation application of PCT/JP2011/070126, filed Sep. 5, 2011, which claims priority to Japanese Patent Application No. 2010-268744, filed Dec. 1, 2010. The contents of these applications are incorporated herein by reference in their entirety.

### BACKGROUND OF THE INVENTION

1. Field of the Invention

The present disclosure relates to a power converter.

2. Description of the Related Art

Hitherto, a power converter that includes a power-conversion semiconductor element is available (see, for example, Japanese Unexamined Patent Application Publication No. 2008-103623).

The foregoing publication discloses a semiconductor device (power converter) that includes an insulated-gate bipolar transistor (IGBT, a power-conversion semiconductor element), a lead frame electrically connected to the IGBT, and a mold resin provided to include therein the IGBT and the lead frame. In this semiconductor device, switching of the IGBT causes a current to flow between the collector and emitter of the IGBT.

### SUMMARY OF THE INVENTION

According to an aspect of the disclosure, there is provided a power converter including a power converter body portion. The power converter body portion includes a first conductive plate and a second conductive plate that are disposed with a distance therebetween in the power converter body portion, a first power-conversion semiconductor element that is disposed on a front surface of the first conductive plate, a second power-conversion semiconductor element that is disposed on a front surface of the second conductive plate and that is electrically connected to the first power-conversion semiconductor element, and a capacitor that is disposed between the first power-conversion semiconductor element and the second power-conversion semiconductor element so as to be connected to the first conductive plate and the second conductive plate in the power converter body portion and that suppresses a surge voltage.

### BRIEF DESCRIPTION OF THE DRAWINGS

FIG. 1 is an exploded perspective view illustrating the configuration of a power module according to a first embodiment of the present disclosure;

FIG. 2 is a cross-sectional view taken along an X direction illustrating the configuration of the power module according to the first embodiment of the present disclosure;

FIG. 3 is a side view of the power module according to the first embodiment of the present disclosure;

FIG. 4 is a plan view of a power module body portion according to the first embodiment of the present disclosure;

FIG. 5 is a plan view of a state where a case of the power module body portion is removed according to the first embodiment of the present disclosure;

FIG. 6 is a cross-sectional view taken along the line VI-VI in FIG. 4;

FIG. 7 is a cross-sectional view taken along the line VII-VII in FIG. 4;

FIG. 8 is a cross-sectional view taken along the line VIII-VIII in FIG. 4;

FIG. 9 is a cross-sectional view taken along the line IX-IX in FIG. 4;

FIG. 10 is an exploded perspective view illustrating the internal configuration of the power module body portion according to the first embodiment of the present disclosure;

FIG. 11 is a circuit diagram of the power module according to the first embodiment of the present disclosure;

FIG. 12 is a circuit diagram of a chopper circuit to which the power module according to the first embodiment of the present disclosure is applied;

FIG. 13 is a circuit diagram of a chopper circuit to which a power module according to a comparative example is applied;

FIG. 14 is a diagram illustrating a result of simulation of the chopper circuit to which the power module according to the comparative example is applied;

FIG. 15 is a diagram illustrating a result of simulation of the chopper circuit to which the power module according to the first embodiment of the present disclosure is applied;

FIG. 16 is a plan view of a side provided with P-side semiconductor elements of a power module body portion according to a second embodiment of the present disclosure;

FIG. 17 is a plan view of a side provided with N-side semiconductor elements of the power module body portion according to the second embodiment of the present disclosure;

FIG. 18 is a side view of the power module body portion according to the second embodiment of the present disclosure viewed from the side indicated by arrow Y1;

FIG. 19 is a side view of the power module body portion according to the second embodiment of the present disclosure viewed from the side indicated by arrow X2; and

FIG. 20 is an exploded perspective view illustrating the internal configuration of the power module body portion according to the second embodiment of the present disclosure.

### DESCRIPTION OF THE EMBODIMENTS

Hereinafter, embodiments of the present disclosure will be described with reference to the drawings.

### First Embodiment

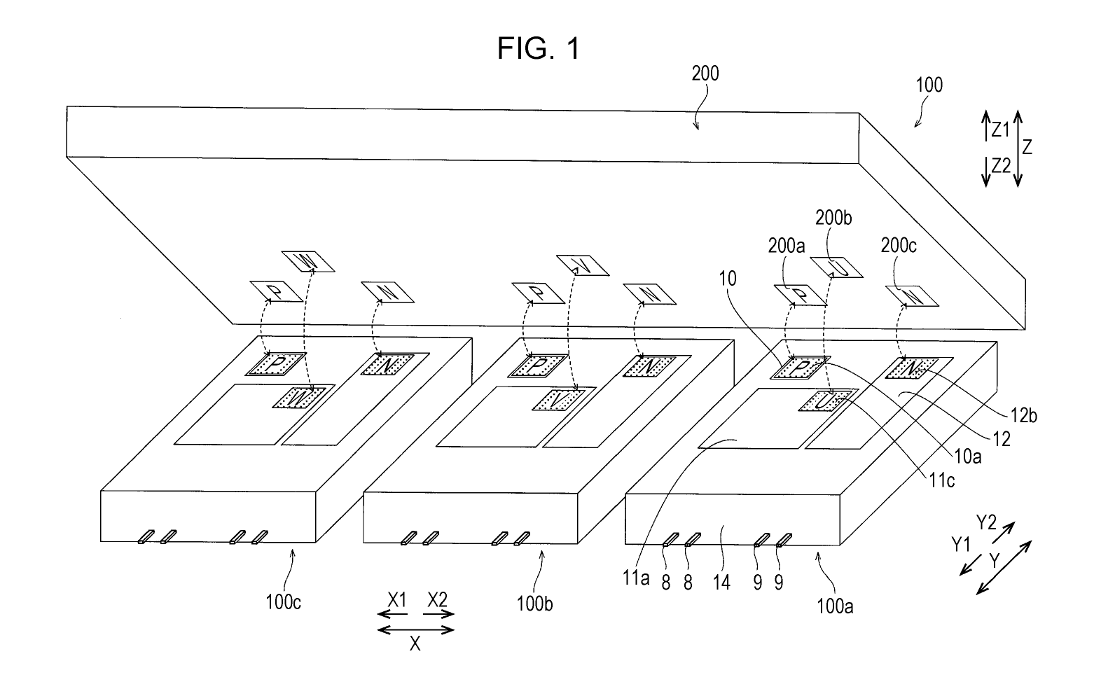

First, the configuration of a power module 100 according to a first embodiment of the present disclosure will be described with reference to FIGS. 1 to 3. The power module 100 is an example of the “power converter” that is disclosed.

As illustrated in FIG. 1, the power module 100 according to the first embodiment of the present disclosure includes three power module body portions 100a, 100b, and 100c, and a wiring board 200. Each of the power module body portions 100a, 100b, and 100c is an example of the “power converter body portion” that is disclosed.

The power module 100 constitutes a three-phase inverter circuit that is to be connected to a motor or the like. In the power module body portions 100a, 100b, and 100c included in the power module 100, the portions on the side indicated by arrow X1 function as upper arms (P side) of the three-phase inverter circuit. In the power module body portions 100a, 100b, and 100c, the portions on the side indicated by arrow X2 function as lower arms (N side) of the three-phase inverter circuit. The power module body portions 100a, 100b, and 100c perform power conversion for a U-phase, a V-phase, and a W-phase, respectively. The power module body portions 100a, 100b, and 100c have substantially the same configuration, and thus description will be given below mainly of the power module body portion 100a.

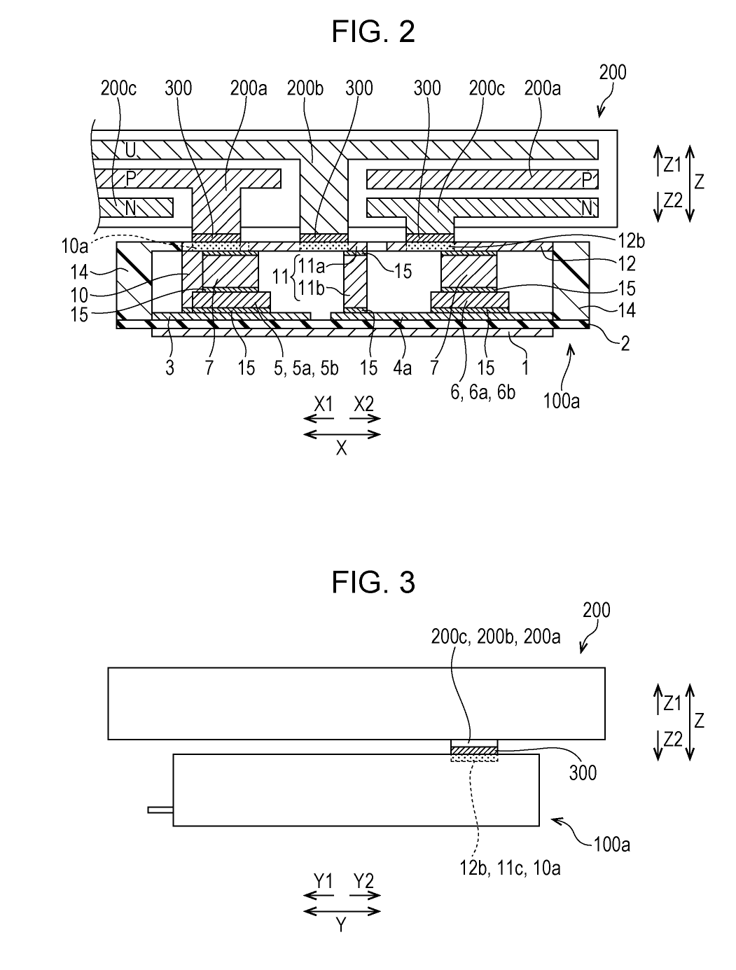

As illustrated in FIG. 2, a P-phase busbar 200a, a U-phase busbar 200b, and an N-phase busbar 200c, each formed of a conductive metal plate, are provided in the wiring board 200. As illustrated in FIG. 1, portions of the P-phase busbar 200a, the U-phase busbar 200b, and the N-phase busbar 200c are exposed on the lower surface (the surface on the side indicted by arrow Z2) of the wiring board 200 so as to correspond to a P-side terminal connection portion 10a, a U-phase terminal connection portion 11c, and an N-side terminal connection portion 12b (described below) of the power module body portion 100a. In the wiring board 200, a V-phase busbar and a W-phase busbar are provided so as to correspond to a V-phase terminal connection portion and a W-phase terminal connection portion (described below) of the power module body portions 100b and 100c.

The power module body portion 100a is configured to be electrically connected to the wiring board 200 on the upper surface (the surface on the side indicated by arrow Z1) of the power module body portion 100a. Specifically, as illustrated in FIGS. 1 to 3, the power module body portion 100a is configured so that the P-side terminal connection portion 10a, the U-phase terminal connection portion 11c, and the N-side terminal connection portion 12b (described below, see dotted portions) of the power module body portion 100a are connected to the portions of the P-phase busbar 200a, the U-phase busbar 200b, and the N-phase busbar 200c of the wiring board 200 that are exposed on the lower surface (the surface on the side indicated by arrow Z2) of the wiring board 200, via bump electrodes 300.

As illustrated in FIG. 3, the power module body portion 100a and the wiring board 200 are configured to be disposed with a certain distance (space) therebetween. This space is filled with, for example, a thermal conductive resin or the like. Accordingly, it becomes possible to fix the power module body portion 100a, the power module body portion 100b, and the power module body portion 100c, and the wiring board 200, with the heat release effect of the power module 100 being increased. Also, the resin suppresses corrosion of the P-phase busbar 200a, the N-phase busbar 200c, and the U-phase busbar 200b that connect the power module body portion 100a and the wiring board 200. The resin may be replaced with a thermal conductive compound.

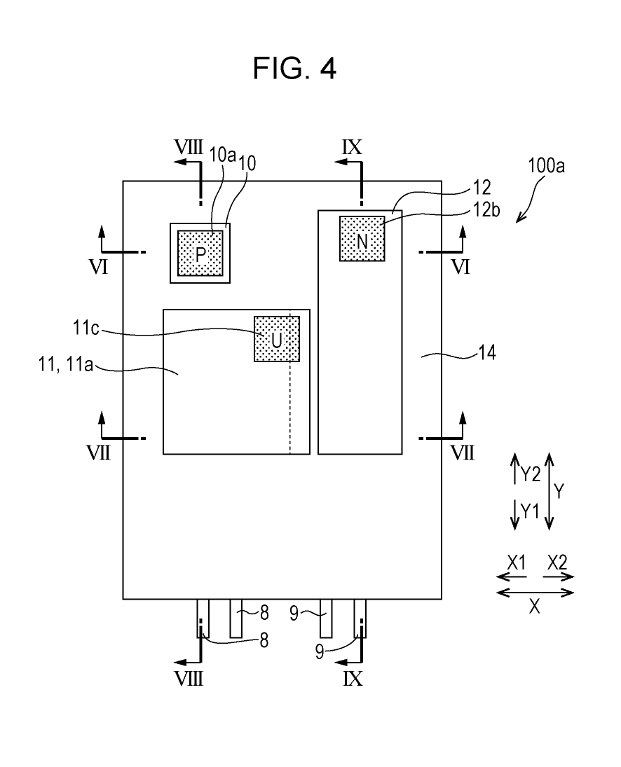

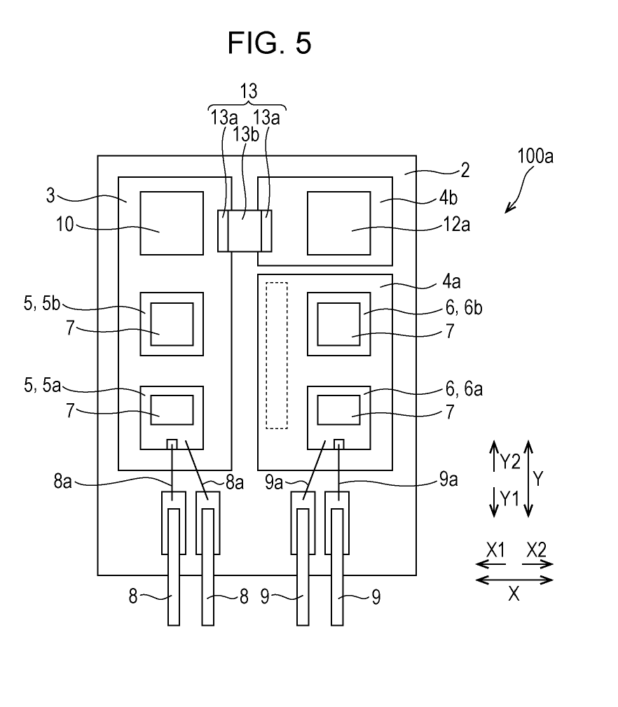

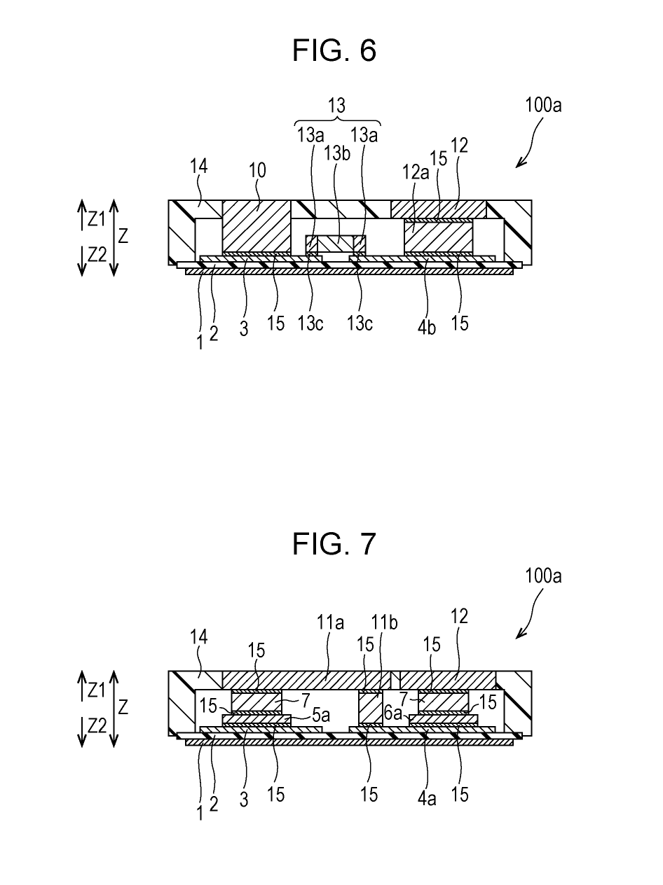

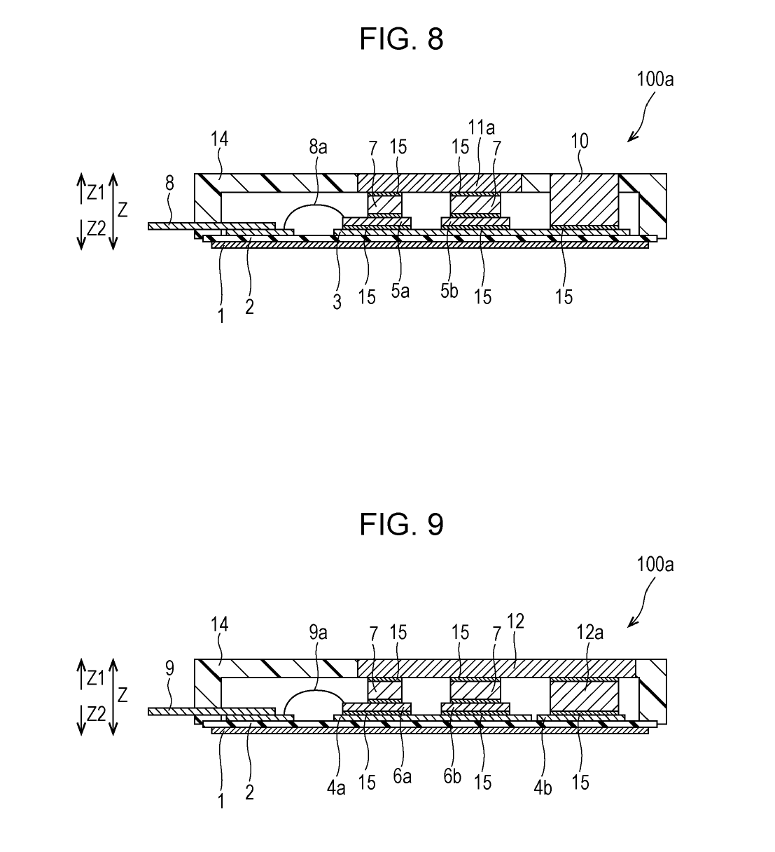

Next, a specific configuration of the power module body portion 100a according to the first embodiment of the present disclosure will be described with reference to FIGS. 4 to 11.

As illustrated in FIGS. 4 to 10, the power module body portion 100a includes a metal plate 1, an insulating substrate 2, a P-side conductive plate 3, a first N-side conductive plate 4a, a second N-side conductor plate 4b, two P-side semiconductor elements 5, two N-side semiconductor elements 6, four columnar electrodes 7, two P-side control terminals 8, two N-side control terminals 9, a P-side terminal 10, a U-phase terminal 11, an N-side terminal 12, and a snubber capacitor 13. The metal plate 1 is an example of the “back-surface conductive plate” that is disclosed. The P-side conductive plate 3 is an example of the “first conductive plate” that is disclosed. The first N-side conductive plate 4a is an example of the “second conductive plate” and the “element-side second conductive plate” that are disclosed. The second N-side conductive plate 4b is an example of the “second conductive plate” and the “terminal-side second conductive plate” that are disclosed. The columnar electrode 7 is an example of the “electrode conductor” that is disclosed. The N-side terminal 12 is an example of the “negative-side input/output terminal” that is disclosed. The snubber capacitor 13 is an example of the “capacitor” that is disclosed.

The P-side conductive plate 3, the first N-side conductive plate 4a, the second N-side conductive plate 4b, the P-side semiconductor elements 5, the N-side semiconductor elements 6, the columnar electrodes 7, and the snubber capacitor 13 are covered by a case 14 composed of resin or the like. The P-side terminal 10, the U-phase terminal 11, and the N-side terminal 12 are exposed on the upper surface (the surface on the side indicated by arrow Z1) of the case 14. The metal plate 1, the P-side conductive plate 3, the first N-side conductive plate 4a, and the second N-side conductive plate 4b are composed of metal, such as copper. The insulating substrate 2 is composed of an insulating material, such as ceramic. In the power module body portion 100a, the metal plate 1, the insulating substrate 2, and the P-side conductive plate 3 constitute a P-side insulating circuit board, and the metal plate 1, the insulating substrate 2, the first N-side conductive plate 4a, and the second N-side conductive plate 4b constitute an N-side insulating circuit board. The P-side semiconductor elements 5 correspond to an example of the “first power-conversion semiconductor element” that is disclosed. The N-side semiconductor elements 6 correspond to an example of the “second power-conversion semiconductor element” that is disclosed.

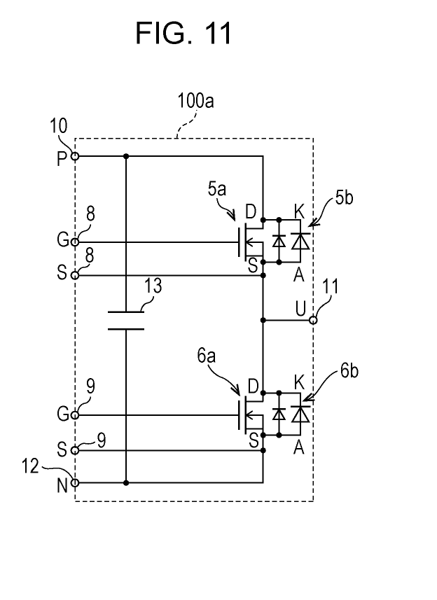

The two P-side semiconductor elements 5 are constituted by one P-side transistor element 5a and one P-side diode element 5b. The P-side transistor 5a is, for example, a metal-oxide-semiconductor field-effect transistor (MOSFET). The P-side diode element 5b is, for example, a Schottky barrier diode (SBD). The P-side diode element 5b has a function as a free wheel diode. As illustrated in FIG. 11, the P-side transistor element 5a and the P-side diode element 5b are electrically connected in parallel to each other. Specifically, the cathode electrode of the P-side diode element 5b is electrically connected to the drain electrode of the P-side transistor element 5a. The anode electrode of the P-side diode element 5b is electrically connected to the source electrode of the P-side transistor element 5a. The P-side transistor element 5a is an example of the “voltage-driven transistor element” that is disclosed. The P-side diode element 5b is an example of the “free wheel diode element” that is disclosed.

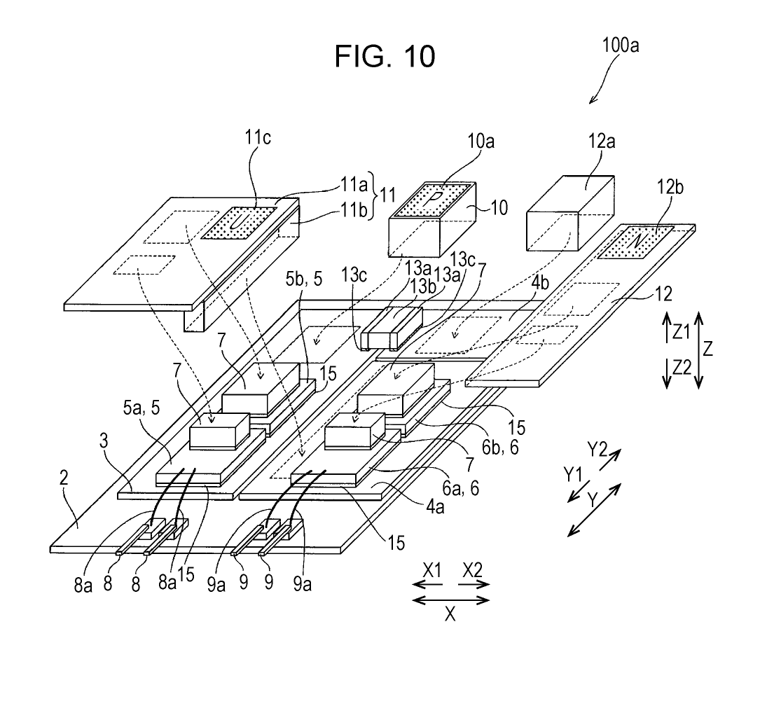

The drain electrode of the P-side transistor element 5a and the cathode electrode of the P-side diode element 5b are electrically connected to the P-side conductive plate 3. As illustrated in FIG. 10, the lower surfaces (the surfaces on the side indicated by arrow Z2) of the P-side transistor element 5a and the P-side diode element 5b are connected to the upper surface (the surface on the side indicated by arrow Z1) of the P-side conductive plate 3 via joint materials 15 composed of solder. The P-side transistor element 5a and the P-side diode element 5b are disposed side by side in the Y direction with a certain distance therebetween on the front surface of the P-side conductive plate 3. The P-side transistor element 5a is disposed on the side indicated by arrow Y1 with respect to the P-side diode element 5b. Instead of the joint materials 15 composed of solder, joint materials composed of Ag nanopaste may be used.

Likewise, the two N-side semiconductor elements 6 are constituted by one N-side transistor element 6a and one N-side diode element 6b. The N-side diode element 6b has a function as a free wheel diode. As illustrated in FIG. 11, the N-side transistor element 6a and the N-side diode element 6b are electrically connected in parallel to each other. Specifically, the cathode electrode of the N-side diode element 6b is electrically connected to the drain electrode of the N-side transistor element 6a. The anode electrode of the N-side diode element 6b is electrically connected to the source electrode of the N-side transistor element 6a. The N-side transistor element 6a is an example of the “voltage-driven transistor element” that is disclosed. The N-side diode element 6b is an example of the “free wheel diode element” that is disclosed.

As illustrated in FIG. 10, the N-side transistor element 6a and the N-side diode element 6b are disposed side by side in the Y direction on the upper surface (the surface on the side indicated by arrow Z1) of the first N-side conductive plate 4a. The N-side transistor element 6a is disposed on the side indicated by arrow Y1 with respect to the N-side diode element 6b. The P-side transistor element 5a and the N-side transistor element 6a, and the P-side diode element 5b and the N-side diode element 6b are disposed side by side in the X direction. The P-side transistor element 5a and the P-side diode element 5b are disposed on the side indicated by arrow X1 with respect to the N-side transistor element 6a and the N-side diode element 6b.

The two P-side control terminals 8 are respectively connected to a gate electrode and a source electrode provided on the upper surface (the surface on the side indicated by arrow Z1) of the P-side transistor element 5a via wires 8a using wire bonding. Likewise, the two N-side control terminals 9 are respectively connected to a gate electrode and a source electrode provided on the upper surface of the N-side transistor element 6a via wires 9a using wire bonding. The two P-side control terminals 8 and the two N-side control terminals 9 protrude in the direction indicated by arrow Y1 from the side surface on the side indicated by arrow Y1 of the case 14 of the power module body portion 100a.

The P-side terminal 10 is configured to be connected to the upper surface (the surface on the side indicated by arrow Z1) of the P-side conductive plate 3 via a joint material 15. Further, the P-side terminal 10 is configured to be electrically connected to the drain electrode of the P-side transistor element 5a and the cathode electrode of the P-side diode element 5b via the P-side conductive plate 3. The P-side terminal 10 is formed in a substantially column shape extending in the Z direction.

The U-phase terminal 11 is constituted by a U-phase terminal portion 11a and a P side-N side connection electrode portion 11b. As illustrated in FIG. 10, the U-phase terminal portion 11a is formed in a substantially flat plate shape extending in the X and Y directions. The P side-N side connection electrode portion 11b is formed in a substantially column shape extending in the Y and Z directions.

The U-phase terminal portion 11a is configured to be connected to the upper surfaces of the two columnar electrodes 7 that are connected to the upper surfaces (the surfaces on the side indicated by arrow Z1) of the P-side transistor element 5a and the P-side diode element 5b via joint materials 15. Further, the U-phase terminal portion 11a is configured to be electrically connected to the source electrode of the P-side transistor element 5a and the anode electrode of the P-side diode element 5b via the two columnar electrodes 7. The columnar electrodes 7 are formed in a substantially column shape extending in the Z direction, and the upper surfaces thereof are substantially flat.

The P side-N side connection electrode portion 11b is configured to be connected to the upper surface (the surface on the side indicated by arrow Z1) of the first N-side conductive plate 4a via a joint material 15. The P side-N side connection electrode portion 11b is provided to electrically connect the P-side semiconductor elements 5 (the P-side transistor element 5a and the P-side diode element 5b) that are connected to the U-phase terminal portion 11a, and the N-side semiconductor elements 6 (the N-side transistor element 6a and the N-side diode element 6b) that are connected to the first N-side conductive plate 4a. Specifically, the source electrode of the P-side transistor element 5a and the anode electrode of the P-side diode element 5b, and the drain electrode of the N-side transistor element 6a and the cathode electrode of the N-side diode element 6b, are electrically connected to each other by the P side-N side connection electrode portion 11b.

The N-side terminal 12 is formed in a substantially flat plate shape extending in the X and Y directions, and is connected to the upper surface (the surface on the side indicated by arrow Z1) of the second N-side conductive plate 4b via a connection electrode 12a. Further, the N-side terminal 12 is configured to be connected to the upper surfaces of the two columnar electrodes 7 that are connected to the upper surfaces (the surfaces on the side indicated by arrow Z1) of the N-side transistor element 6a and the N-side diode element 6b via joint materials 15. Further, the N-side terminal 12 is configured to be electrically connected to the source electrode of the N-side transistor element 6a and the anode electrode of the N-side diode element 6b via the two columnar electrodes 7.

The P-side terminal connection portion 10a, the U-phase terminal connection portion 11c, and the N-side terminal connection portion 12b (see dotted portions in FIGS. 1, 4, and 10) are provided on the upper surfaces (the surfaces on the side indicated by arrow Z1) of the P-side terminal 10, the U-phase terminal 11, and the N-side terminal 12, respectively. The P-side terminal connection portion 10a, the U-phase terminal connection portion 11c, and the N-side terminal connection portion 12b are provided to establish electrical connection with the wiring board 200. The P-side terminal connection portion 10a, the U-phase terminal connection portion 11c, and the N-side terminal connection portion 12b function as inlets and outlets for current that flows in and out between the power module body portion 100a and the wiring board 200. A P-side terminal connection portion, a V-phase terminal connection portion, and an N-side terminal connection portion are provided in the power module body portion 100b, and a P-side terminal connection portion, a W-phase terminal connection portion, and an N-side terminal connection portion are provided in the power module body portion 100c, so as to correspond to the above-described P-side terminal connection portion 10a, the U-phase terminal connection portion 11c, and the N-side terminal connection portion 12b.

Here, in the first embodiment, the snubber capacitor 13 is provided to be directly connected to the P-side conductive plate 3 and the second N-side conductive plate 4b. The snubber capacitor 13 is disposed so as to straddle the P-side conductive plate 3 and the second N-side conductive plate 4b. An electrode 13a is provided at the end portion on the side indicated by arrow X1 of the snubber capacitor 13 and at the end portion on the side indicated by arrow X2 of the snubber capacitor 13. A portion 13b between the electrodes 13a of the snubber capacitor 13 is composed of ceramic. The electrodes 13a are connected to the P-side conductive plate 3 and the second N-side conductive plate 4b via solders 13c. Accordingly, the snubber capacitor 13 is electrically connected to the drain electrode of the P-side transistor element 5a and the source electrode of the N-side transistor element 6a. Also, the snubber capacitor 13 is electrically connected to the cathode electrode of the P-side diode element 5b and the anode electrode of the N-side diode element 6b. The snubber capacitor 13 has a function of suppressing a surge voltage that is generated when the P-side transistor element 5a or the N-side transistor element 6a is switched. Instead of the solders 13c, joint materials composed of Ag nanopaste may be used.

In the first embodiment, the snubber capacitor 13 is disposed in a region surrounded by the columnar electrodes 7 in plan view (top view). The snubber capacitor 13 is disposed so as to be directly connected to the P-side conductive plate 3 and the second N-side conductive plate 4b without via lines, on the side opposite to the wiring board 200 in the power module body portion 100a (see FIG. 1).

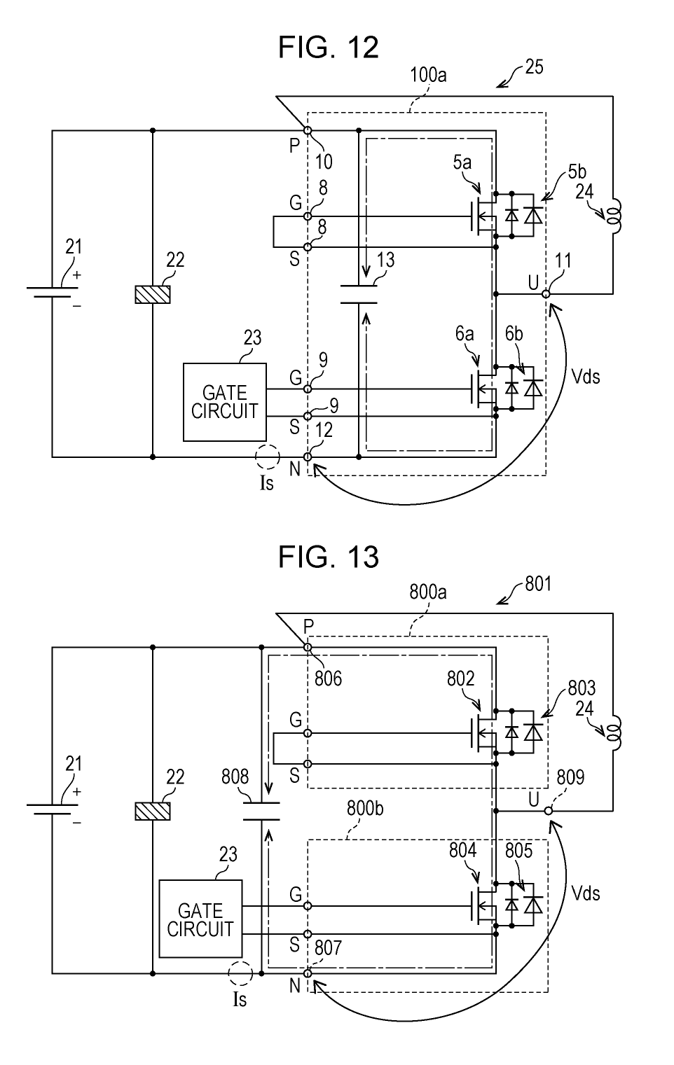

Next, with reference to FIGS. 12 to 15, description will be given of a simulation which was performed regarding suppression of a surge voltage which is generated when the power module body portion is switched.

In this simulation, as illustrated in FIG. 12, a chopper circuit 25, which includes the power module body portion 100a according to the first embodiment (broken line) connected to a DC power supply 21, an electrolytic capacitor 22, a gate circuit 23, and a load reactor 24, was assumed. The DC power supply 21 is connected to the P-side terminal 10 and the N-side terminal 12 of the power module body portion 100a. The electrolytic capacitor 22 is connected between the DC power supply 21 and the P-side terminal 10, and between the DC power supply 21 and the N-side terminal 12. The gate circuit 23 is connected to the N-side control terminals 9. In the chopper circuit 25, a source current Is that flows through the N-side terminal 12 of the power module body portion 100a was determined by the simulation. Also, a voltage Vds between the N-side terminal 12 and the U-phase terminal 11 of the power module body portion 100a was determined by the simulation.

As a comparative example illustrated in FIG. 13, a chopper circuit 801, which includes two power module body portions 800a and 800b (broken lines) connected to the DC power supply 21, the electrolytic capacitor 22, and the gate circuit 23, was assumed. In the power module body portion 800a (800b) according to the comparative example, one P-side transistor element 802 (N-side transistor element 804) and one P-side diode element 803 (N-side diode element 805) are provided. In the chopper circuit 801, a snubber capacitor 808 is provided between a P-side terminal 806 of the power module body portion 800a and an N-side terminal 807 of the power module body portion 800b. In the chopper circuit 801, a source current Is that flows through the N-side terminal 807 of the power module body portion 800b was determined by the simulation. Also, a voltage Vds between the N-side terminal 807 and the U-phase terminal 809 of the power module body portion 800b was determined by the simulation.

In this simulation, it was assumed that the voltage of the DC power supply 21 was 300 V, and that the source current Is when the power module body portion is in an ON-state was 200 A. Also, it was assumed that a carrier frequency (the frequency of modulation waves for determining the pulse width of an output voltage using an inverter at the time of PWM control) was 100 kHz. Further, it was assumed that the wiring inductance in the power module body portions 800a and 800b according to the comparative example was 7.426 nH, and the wiring inductance in the power module body portion 100a according to the first embodiment was 3.0898 nH. In the power module body portion 100a according to the first embodiment, the P-side transistor element 5a, the P-side diode element 5b, the N-side transistor element 6a, and the N-side diode element 6b are provided in the single power module body portion 100a. On the other hand, in the power module body portions 800a and 800b according to the comparative example, the P-side transistor element 802 and the P-side diode element 803, and the N-side transistor element 804 and the N-side diode element 805, are provided in different power module body portions. Thus, the wiring inductance in the power module body portions 800a and 800b according to the comparative example was set to be larger than the wiring inductance in the power module body portion 100a according to the first embodiment.

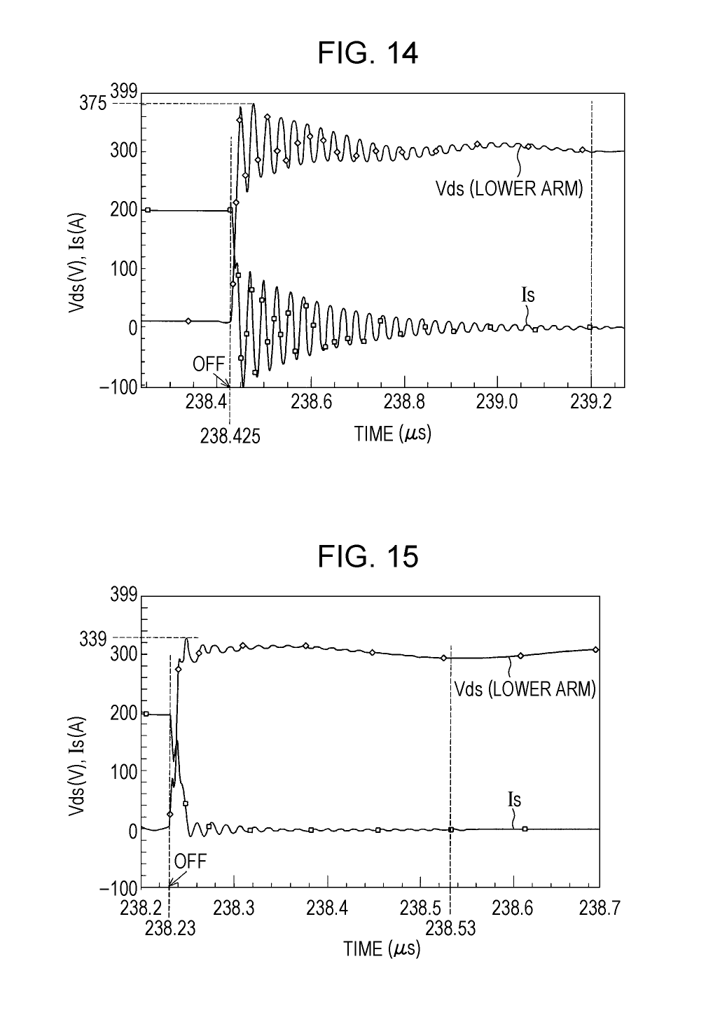

FIG. 14 illustrates the result of the simulation according to the comparative example. The vertical axis represents the voltage (V) and source current Is (A), and the horizontal axis indicates the time. The simulation found that, in a case where the state of the power module body portions 800a and 800b is changed from an ON-state to an OFF-state, the energy accumulated in the wiring inductance resonates in the closed circuit illustrated in FIG. 13 (chained line, LC circuit), and thereby a surge voltage is generated and ringing (a wave-like waveform generated when a signal that steeply changes, such as a pulse signal, passes through a network) occurs.

FIG. 15 illustrates the result of the simulation according to the first embodiment. The simulation found that, in a case where the state of the power module body portion 100a is changed from an ON-state to an OFF-state, the energy accumulated in the wiring inductance resonates in the closed circuit illustrated in FIG. 12 (chained line, LC circuit), and thereby a surge voltage is generated and ringing occurs. In addition, it was determined that the ringing in the simulation according to the comparative example illustrated in FIG. 14 finished 0.775 μs (=239.2−238.425) after the state of the power module body portions 800a and 800b is changed to an OFF-state, whereas the ringing in the simulation according to the first embodiment illustrated in FIG. 15 finished 0.3 μs (=238.53−238.23) after the state of the power module body portion 100a is changed to an OFF-state. That is, it was determined that the ringing in the simulation according to the first embodiment illustrated in FIG. 15 finished earlier. Also, it was determined that the maximum value of the surge voltage was 375 V in the comparative example illustrated in FIG. 14, whereas the maximum value was 339 V in the first embodiment illustrated in FIG. 15. That is, it was determined that the surge voltage was decreased in the first embodiment. It is considered that the wiring inductance of the first embodiment (3.0898 nH) was smaller than the wiring inductance of the comparative example (7.426 nH), and thus the surge current was decreased. In the first embodiment (comparative example), if the snubber capacitor 13 (808) is not provided, the maximum value of the surge voltage is larger than the maximum value of the surge voltage of the comparative example (375 V).

In the first embodiment, as described above, the P-side semiconductor elements 5 disposed on the front surface of the P-side conductive plate 3, and the N-side semiconductor elements 6 disposed on the front surface of the first N-side conductive plate 4a and electrically connected to the P-side semiconductor elements 5, are provided in the power module body portion 100a. Accordingly, compared to a case where the P-side semiconductor elements 5 and the N-side semiconductor elements 6 are separately provided in two different power module body portions, the distance between the P-side semiconductor elements 5 and the N-side semiconductor elements 6 can be reduced, and thus the wiring inductance between the P-side semiconductor elements 5 and the N-side semiconductor elements 6 can be reduced. Further, in the power module body portion 100a, the snubber capacitor 13 is provided between the P-side semiconductor elements 5 and the N-side semiconductor elements 6 so as to be connected to the P-side conductive plate 3 and the second N-side conductive plate 4b. Accordingly, breakdown of the P-side semiconductor elements 5 and the N-side semiconductor elements 6 caused by a surge voltage can be suppressed. Further, compared to a case where the snubber capacitor 13 is provided on a substrate or the like outside the power module body portion 100a, the distance between the snubber capacitor 13, and the P-side semiconductor elements 5 and the N-side semiconductor elements 6 is reduced, and thus the wiring inductance between the snubber capacitor 13, and the P-side semiconductor elements 5 and the N-side semiconductor elements 6 can be reduced.

In the first embodiment, as described above, the snubber capacitor 13 is disposed between the P-side semiconductor elements 5 and the N-side semiconductor elements 6 so as to be directly connected to the P-side conductive plate 3 and the second N-side conductive plate 4b. Accordingly, compared to a case where the snubber capacitor 13 is disposed via lines or the like, the wiring inductance between the snubber capacitor 13, and the P-side conductive plate 3 and the second N-side conductive plate 4b can be reduced.

In the first embodiment, as described above, the snubber capacitor 13 is disposed between the P-side semiconductor elements 5 and the N-side semiconductor elements 6 so as to straddle the P-side conductive plate 3 and the second N-side conductive plate 4b. Accordingly, the snubber capacitor 13 and the P-side conductive plate 3 can be directly connected to each other easily, and the snubber capacitor 13 and the second N-side conductive plate 4b can be directly connected to each other easily.

In the first embodiment, as described above, the source electrode of the P-side semiconductor element 5 and the drain electrode of the N-side semiconductor element 6 are electrically connected to each other, and the snubber capacitor 13 is electrically connected to the drain electrode of the P-side semiconductor element 5 via the P-side conductive plate 3 and is electrically connected to the source electrode of the N-side semiconductor element 6 via the second N-side conductive plate 4b. Accordingly, a surge voltage generated at the time of switching of the P-side semiconductor elements 5 and the N-side semiconductor elements 6 can be suppressed by the snubber capacitor 13.

In the first embodiment, as described above, the power module body portion 100a includes the columnar electrodes 7 that are formed on the front surfaces of the P-side semiconductor elements 5 on the front surface of the P-side conductive plate 3 and the N-side semiconductor elements 6 on the front surface of the first N-side conductive plate 4a, that have a substantially column shape extending upward, and that have upper surfaces which are substantially flat, and the snubber capacitor 13 is disposed in the region surrounded by the columnar electrodes 7 in plan view. Accordingly, unlike in a case where the snubber capacitor 13 is disposed outside the region surrounded by the columnar electrodes 7, an increase in the size of the power module body portion 100a can be suppressed. Further, the columnar electrodes 7 have a substantially column shape extending upward, and have upper surfaces which are substantially flat. Thus, compared to a case where the electrodes are formed of, for example, thin wires, the wiring inductance can be reduced. As a result, it can be suppressed that the P-side semiconductor elements 5 and the N-side semiconductor elements 6 become incapable of operating fast due to a large wiring inductance. Further, the columnar electrodes 7 which are substantially column-shaped enable heat release to be increased compared to a case where thin-wire electrodes are used. Accordingly, the heat release effect can be enhanced.

In the first embodiment, as described above, the power module body portion 100a includes the insulating substrate 2 that has a front surface provided with the P-side conductive plate 3, the first N-side conductive plate 4a, and the second N-side conductive plate 4b, and that has a back surface provided with the metal plate 1, and the snubber capacitor 13 is disposed so as to be directly connected to the P-side conductive plate 3 and the second N-side conductive plate 4b. Accordingly, the P-side conductive plate 3, the first N-side conductive plate 4a, the second N-side conductive plate 4b, and the snubber capacitor 13 are formed on the front surface of the single insulating substrate 2. Thus, unlike in a case where the P-side conductive plate 3, the first N-side conductive plate 4a, the second N-side conductive plate 4b, and the snubber capacitor 13 are formed on different insulating substrates, an increase in the size of the power module body portion 100a can be suppressed.

In the first embodiment, as described above, the snubber capacitor 13 is disposed so as to be directly connected to the P-side conductive plate 3 and the second N-side conductive plate 4b on the side opposite to the wiring board 200 in the power module body portion 100a. Accordingly, the snubber capacitor 13 is disposed on the side of the P-side conductive plate 3 and the second N-side conductive plate 4b, and thus the distance between the snubber capacitor 13, and the P-side conductive plate 3 and the second N-side conductive plate 4b is reduced. Accordingly, the wiring inductance between the snubber capacitor 13, and the P-side conductive plate 3 and the second N-side conductive plate 4b can be reduced.

### Second Embodiment

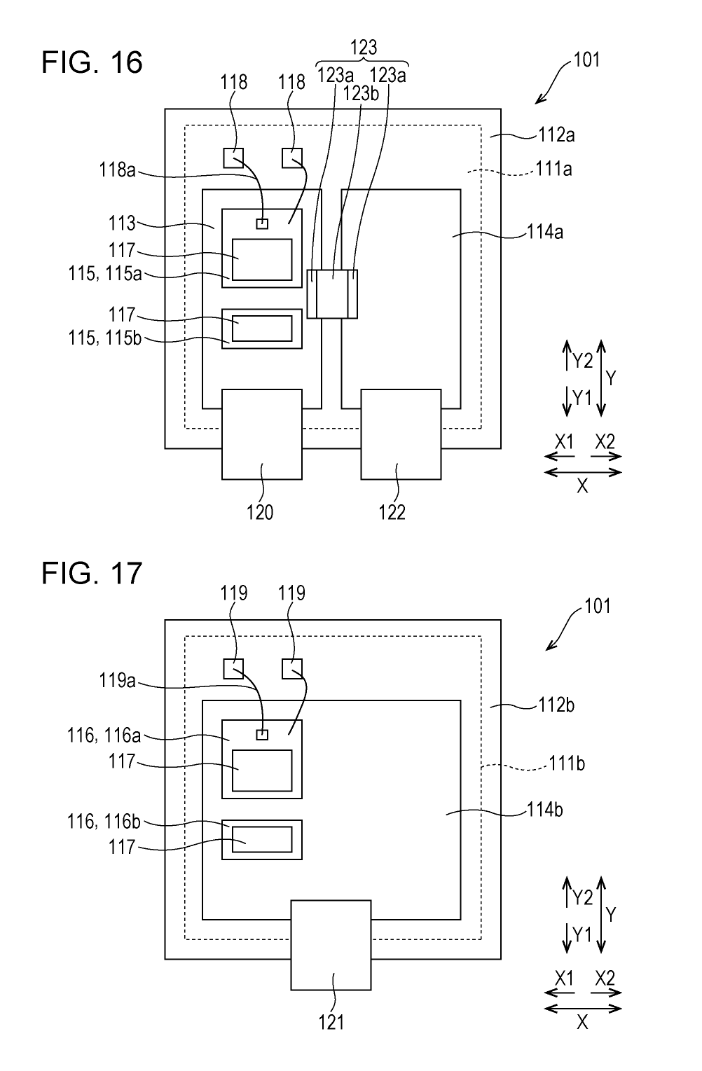

Next, a power module body portion 101 according to a second embodiment will be described with reference to FIGS. 16 to 20. In the second embodiment, unlike in the first embodiment in which the P-side semiconductor elements and the N-side semiconductor elements are provided on the front surface of the single insulating substrate, the P-side semiconductor elements and the N-side semiconductor elements are provided so as to be sandwiched between two insulating substrates.

As illustrated in FIGS. 16 and 18 to 20, in the power module body portion 101, an insulating substrate 112a and an insulating substrate 112b are disposed so as to face each other. The insulating substrate 112a is provided with a metal plate 111a, a P-side conductive plate 113, a first N-side conductive plate 114a, two P-side semiconductor elements 115, two columnar electrodes 117, two P-side control terminals 118, a P-side terminal 120, an N-side terminal 122, and a snubber capacitor 123. The metal plate 111a is grounded. The metal plate 111a is an example of the “back-surface conductive plate” that is disclosed. The insulating substrate 112a and the insulating substrate 112b are an example of the “first insulating substrate” and an example of the “second insulating substrate” that are disclosed, respectively. The P-side conductive plate 113 is an example of the “first conductive plate” that is disclosed. The first N-side conductive plate 114a is an example of the “second conductive plate” that is disclosed. The columnar electrodes 117 correspond to an example of the “electrode conductor” that is disclosed. The N-side terminal 122 is an example of the “negative-side input/output terminal” that is disclosed. The snubber capacitor 123 is an example of the “capacitor” that is disclosed.

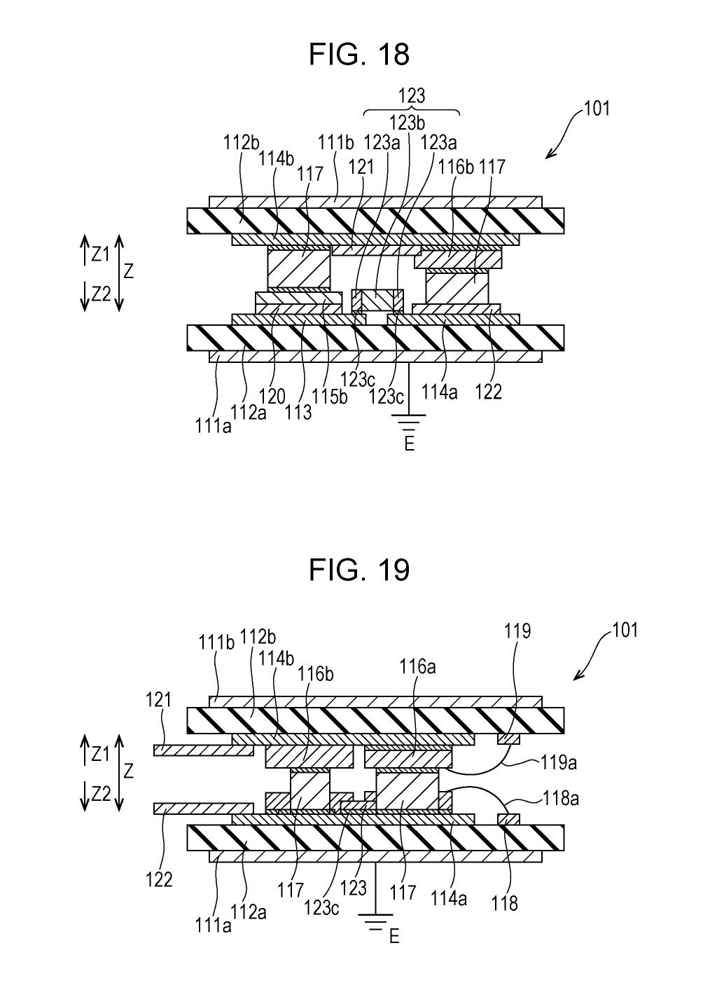

As illustrated in FIGS. 17 to 20, the insulating substrate 112b of the power module body portion 101 is provided with a metal plate 111b, a second N-side conductive plate 114b, two N-side semiconductor elements 116, two columnar electrodes 117, two N-side control terminals 119, and a U-phase terminal 121. Unlike the above-described metal plate 111a, the metal plate 111b is not grounded (see FIGS. 18 and 19). Accordingly, unlike in a case where both the metal plates 111a and 111b are grounded, the stray capacitance between the U-phase terminal 121 and the ground (earth) is small. As a result, common mode noise can be reduced.

The metal plate 111a, the P-side conductive plate 113, the first N-side conductive plate 114a, the metal plate 111b, and the second N-side conductive plate 114b are composed of metal, such as copper. The insulating substrates 112a and 112b are composed of an insulating material, such as ceramic. In the power module body portion 101, the metal plate 111a, the insulating substrate 112a, and the P-side conductive plate 113 constitute a P-side insulating circuit board, and the metal plate 111a, the insulating substrate 112a, and the first N-side conductive plate 114a constitute an N-side insulating circuit board. The metal plate 111b, the insulating substrate 112b, and the second N-side conductive plate 114b constitute an N-side insulating circuit board. The P-side semiconductor elements 115 correspond to an example of the “first power-conversion semiconductor element” that is disclosed. The N-side semiconductor elements 116 correspond to an example of the “second power-conversion semiconductor element” that is disclosed.

As illustrated in FIG. 16, the two P-side semiconductor elements 115 are constituted by one P-side transistor element 115a and one P-side diode element 115b. The P-side transistor 115a is, for example, a MOSFET. The P-side diode element 115b is, for example, an SBD. The P-side diode element 115b has a function as a free wheel diode. As in the first embodiment illustrated in FIG. 11, the P-side transistor element 115a and the P-side diode element 115b are electrically connected in parallel to each other. Specifically, the cathode electrode of the P-side diode element 115b is electrically connected to the drain electrode of the P-side transistor element 115a. The anode electrode of the P-side diode element 115b is electrically connected to the source electrode of the P-side transistor element 115a. The P-side transistor element 115a is an example of the “voltage-driven transistor element” that is disclosed. The P-side diode element 115b is an example of the “free wheel diode element” that is disclosed.

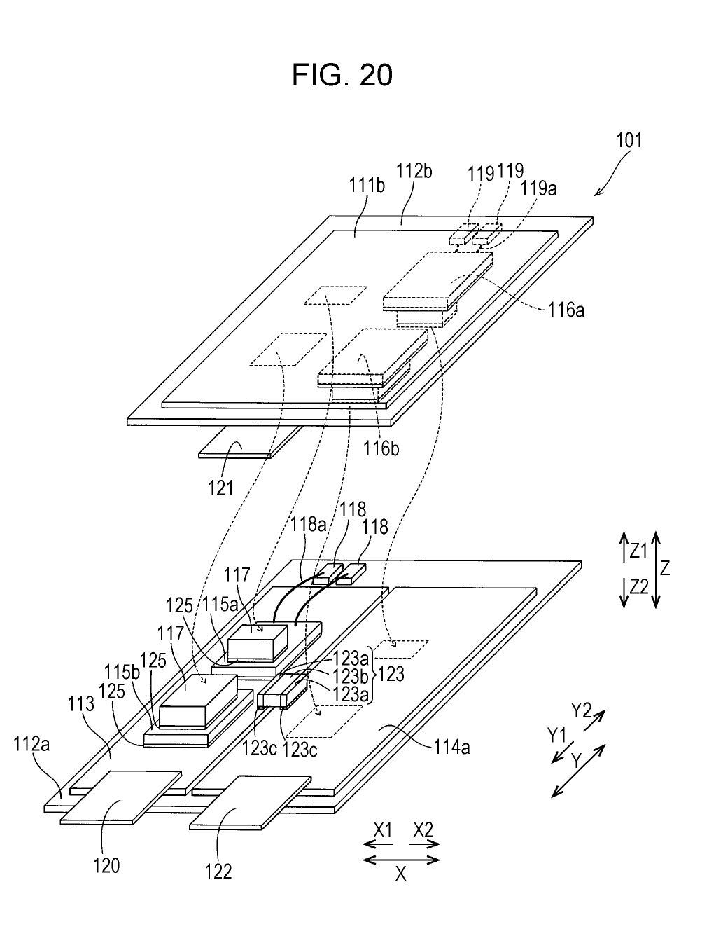

The drain electrode of the P-side transistor element 115a and the cathode electrode of the P-side diode element 115b are electrically connected to the P-side conductive plate 113. As illustrated in FIG. 20, the lower surfaces (the surfaces on the side indicated by arrow Z2) of the P-side transistor element 115a and the P-side diode element 115b are connected to the upper surface (the surface on the side indicated by arrow Z1) of the P-side conductive plate 113 via joint materials 125 composed of solder. The P-side transistor element 115a and the P-side diode element 115b are disposed side by side in the Y direction with a certain distance therebetween on the front surface of the P-side conductive plate 113. The P-side transistor element 115a is disposed on the side indicated by arrow Y2 with respect to the P-side diode element 115b. Instead of the joint materials 125 composed of solder, joint materials composed of Ag nanopaste may be used.

Likewise, as illustrated in FIG. 17, the two N-side semiconductor elements 116 are constituted by one N-side transistor element 116a and one N-side diode element 116b. The N-side diode element 116b has a function as a free wheel diode. As in the first embodiment illustrated in FIG. 11, the N-side transistor element 116a and the N-side diode element 116b are electrically connected in parallel to each other. Specifically, the cathode electrode of the N-side diode element 116b is electrically connected to the drain electrode of the N-side transistor element 116a. The anode electrode of the N-side diode element 116b is electrically connected to the source electrode of the N-side transistor element 116a. The N-side transistor element 116a is an example of the “voltage-driven transistor element” that is disclosed. The N-side diode element 116b is an example of the “free wheel diode element” that is disclosed.

As illustrated in FIG. 20, the N-side transistor element 116a and the N-side diode element 116b are disposed side by side in the Y direction on the upper surface (the surface on the side indicated by arrow Z2) of the second N-side conductive plate 114b. The N-side transistor element 116a is disposed on the side indicated by arrow Y2 with respect to the N-side diode element 116b. In a state where the insulating substrate 112a and the insulating substrate 112b are disposed so as to face each other, the P-side transistor element 115a and the N-side transistor element 116a, and the P-side diode element 115b and the N-side diode element 116b are disposed side by side in the X direction. The P-side transistor element 115a and the P-side diode element 115b are disposed on the side indicated by arrow X1 with respect to the N-side transistor element 116a and the N-side diode element 116b.

As illustrated in FIG. 16, the two P-side control terminals 118 are connected to the gate electrode and the source electrode provided on the upper surface (the surface on the side indicated by arrow Z1) of the P-side transistor element 115a via wires 118a using wire bonding. Likewise, as illustrated in FIG. 17, the two N-side control terminals 119 are connected to the gate electrode and the source electrode provided on the upper surface of the N-side transistor element 116a via wires 119a using wire bonding.

As illustrated in FIG. 16, the P-side terminal 120 is configured to be connected to the upper surface (the surface on the side indicated by arrow Z1) of the P-side conductive plate 113. Also, the P-side terminal 120 is configured to be electrically connected to the drain electrode of the P-side transistor element 115a and the cathode electrode of the P-side diode element 115b via the P-side conductive plate 113. The P-side terminal 120 is formed in a substantially flat plate shape extending in the X and Y directions.

The N-side terminal 122 is configured to be connected to the upper surface (the surface on the side indicated by arrow Z1) of the first N-side conductive plate 114a. Also, the N-side terminal 122 is configured to be electrically connected to the source electrode of the N-side transistor element 116a and the anode electrode of the N-side diode element 116b via the first N-side conductive plate 114a in a state where the insulating substrate 112a and the insulating substrate 112b are disposed so as to face each other. The N-side terminal 122 is formed in a substantially flat plate shape extending in the X and Y directions.

As illustrated in FIG. 17, the U-phase terminal 121 is configured to be connected to the upper surface (the surface on the side indicated by arrow Z2) of the second N-side conductive plate 114b. Also, the U-phase terminal 121 is configured to be electrically connected to the drain electrode of the N-side transistor element 116a and the cathode electrode of the N-side diode element 116b via the second N-side conductive plate 114b. The U-phase terminal 121 is formed in a substantially flat plate shape extending in the X and Y directions.

The P-side terminal 120, the N-side terminal 122, and the U-phase terminal 121 are provided to establish electrical connection with a wiring board (not illustrated). The P-side terminal 120, the N-side terminal 122, and the U-phase terminal 121 function as inlets and outlets for current that flows in and out between the power module body portion 101 and the wiring board.

Here, in the second embodiment, as illustrated in FIG. 16, the snubber capacitor 123 is disposed so as to be directly connected to, without via lines, the P-side conductive plate 113 and the first N-side conductive plate 114a provided on the insulating substrate 112a side. The snubber capacitor 123 is disposed so as to straddle the P-side conductive plate 113 and the first N-side conductive plate 114a. An electrode 123a is provided at the end portion on the side indicated by arrow X1 of the snubber capacitor 123 and at the end portion on the side indicated by arrow X2 of the snubber capacitor 123. A portion 123b between the electrodes 123a of the snubber capacitor 123 is composed of ceramic. The electrodes 123a are connected to the P-side conductive plate 113 and the first N-side conductive plate 114a via solders 123c. Accordingly, the snubber capacitor 123 is electrically connected to the drain electrode of the P-side transistor element 115a and the source electrode of the N-side transistor element 116a in a state where the insulating substrate 112a and the insulating substrate 112b are disposed so as to face each other. Also, the snubber capacitor 123 is electrically connected to the cathode electrode of the P-side diode element 115b and the anode electrode of the N-side diode element 116b. The power module body portion 101 performs power conversion for the U-phase. The power module body portions that perform power conversion for the V-phase and W-phase have substantially the same configuration as the power module body portion 101.

In the second embodiment, as described above, the power module body portion 101 includes the insulating substrate 112a that has a front surface provided with the P-side conductive plate 113 and the first N-side conductive plate 114a and that has a back surface provided with the metal plate 111a, and the insulating substrate 112b that faces the insulating substrate 112a with the P-side semiconductor elements 115 and the N-side semiconductor elements 116 sandwiched between the insulating substrates 112a and 112b. Further, the snubber capacitor 123 is disposed so as to be directly connected to the P-side conductive plate 113 and the first N-side conductive plate 114a on the insulating substrate 112a side. Accordingly, the snubber capacitor 123 is disposed on the side of the P-side conductive plate 113 and the first N-side conductive plate 114a, and thus the distance between the snubber capacitor 123, and the P-side conductive plate 113 and the first N-side conductive plate 114a is reduced. Accordingly, the wiring inductance between the snubber capacitor 123, and the P-side conductive plate 113 and the first N-side conductive plate 114a can be reduced.

It is to be considered that the embodiments disclosed herein are examples from every viewpoint and are not restrictive. The scope of the present disclosure is defined by the scope of the claims, not by the description of the embodiments given above. Furthermore, all the modifications that are equivalent to the scope of the claims in the meaning and scope are included in the scope of the present disclosure.

For example, in the above-described first and second embodiments, a MOSFET and an SBD are used as the power-conversion semiconductor elements according to the present disclosure, but the present disclosure is not limited thereto. In the present disclosure, semiconductor elements other than a MOSFET and an SBD may be used as long as the semiconductor elements serve as power-conversion semiconductor elements.

In the above-described first and second embodiments, a MOSFET is used as the voltage-driven transistor according to the present disclosure, but the present disclosure is not limited thereto. In the present disclosure, other types of transistors, such as an IGBT, may be used as long as the transistors serve as voltage-driven transistors.

In the above-described first and second embodiments, an SBD is used as a free wheel diode, but the present disclosure is not limited thereto. In the present disclosure, other types of diodes, such as a fast recovery diode (FRD), may be used as long as the diodes serve as free wheel diodes.

In the above-described first and second embodiments, a set of a MOSFET and an SBD is disposed on each of the P side and N side of each power module body portion, but the present disclosure is not limited thereto. In the present disclosure, a plurality of sets of a MOSFET and an SBD may be disposed on each of the P side and N side of each power module body portion.

In the above-described first and second embodiments, the snubber capacitor is disposed so as to be directly connected to, using solder, the P-side conductive plate and the first N-side conductive plate without via lines, but the present disclosure is not limited thereto. In the present disclosure, the snubber capacitor may be provided inside the power module body portion. For example, the snubber capacitor may be disposed between the P-side conductive plate and the first N-side conductive plate via short lines so as to be connected to the P-side conductive plate and the first N-side conductive plate.

It should be understood by those skilled in the art that various modifications, combinations, sub-combinations and alterations may occur depending on design requirements and other factors insofar as they are within the scope of the appended claims or the equivalents thereof.

What is claimed is:

1. A power converter comprising:
a power converter body portion,
the power converter body portion including
a first conductive plate and a second conductive plate that are disposed with a distance therebetween in the power converter body portion,
a first power-conversion semiconductor element that is disposed on a front surface of the first conductive plate,
a second power-conversion semiconductor element that is disposed on a front surface of the second conductive plate and that is electrically connected to the first power-conversion semiconductor element, and
a capacitor that is disposed between the first power-conversion semiconductor element and the second power-conversion semiconductor element so as to be connected to the first conductive plate and the second conductive plate in the power converter body portion and that suppresses a surge voltage.

2. The power converter according to claim 1, wherein the capacitor is disposed between the first power-conversion semiconductor element and the second power-conversion semiconductor element so as to be directly connected to the first conductive plate and the second conductive plate.

3. The power converter according to claim 1, wherein the capacitor is disposed between the first power-conversion semiconductor element and the second power-conversion semiconductor element so as to straddle the first conductive plate and the second conductive plate.

4. The power converter according to claim 1, wherein
one electrode of the first power-conversion semiconductor element and one electrode of the second power-conversion semiconductor element are electrically connected to each other, and
the capacitor is electrically connected to the other electrode of the first power-conversion semiconductor element via the first conductive plate and is electrically connected to the other electrode of the second power-conversion semiconductor element via the second conductive plate.

5. The power converter according to claim 1, wherein
the power converter body portion further includes an insulating substrate that has a front surface provided with the first conductive plate and the second conductive plate and that has a back surface provided with a back-surface conductive plate,
the second conductive plate includes an element-side second conductive plate provided with the second power-conversion semiconductor element and a terminal-side second conductive plate provided with a negative-side input/output terminal, and
the capacitor is disposed so as to be directly connected to the first conductive plate and the terminal-side second conductive plate.

6. The power converter according to claim 5, further comprising:
a wiring board that is electrically connected to the first power-conversion semiconductor element and the second power-conversion semiconductor element on a side opposite to the first conductive plate and the second conductive plate of the first power-conversion semiconductor element and the second power-conversion semiconductor element,
wherein the capacitor is disposed so as to be directly connected to the first conductive plate and the second conductive plate on a side opposite to the wiring board inside the power converter body portion.

7. The power converter according to claim 1, wherein
the power converter body portion further includes
a first insulating substrate that has a front surface provided with the first conductive plate and the second conductive plate and that has a back surface provided with a back-surface conductive plate, and
a second insulating substrate that is disposed so as to face the first insulating substrate, the first power-conversion semiconductor element and the second power-conversion semiconductor element being sandwiched between the first insulating substrate and the second insulating substrate, and
the capacitor is disposed so as to be directly connected to the first conductive plate and the second conductive plate on a side of the first insulating substrate.

8. The power converter according to claim 1, wherein
each of the first power-conversion semiconductor element and the second power-conversion semiconductor element includes a voltage-driven transistor element, and
the capacitor is disposed between the voltage-driven transistor element formed on the first conductive plate and the voltage-driven transistor element formed on the second conductive plate so as to be directly connected to the first conductive plate and the second conductive plate in the power converter body portion.

9. The power converter according to claim 8, wherein
each of the first power-conversion semiconductor element and the second power-conversion semiconductor element includes a free wheel diode element that is connected in parallel to the voltage-driven transistor element, and
the capacitor is disposed between the free wheel diode element formed on the first conductive plate and the free wheel diode element formed on the second conductive plate so as to be directly connected to the first conductive plate and the second conductive plate in the power converter body portion.
